(19) United States
(12) Patent Application Publication
(10) Pub. No.: US 2025/0056657 A1
(43) Pub. Date: Feb. 13, 2025

(54) MECHANISM FOR CELL ACTIVATION

(71) Applicant: NOKIA TECHNOLOGIES OY, Espoo (FI)

(72) Inventors: Chunli WU, Beijing (CN); Lei DU, Beijing (CN); Naizheng ZHENG, Beijing (CN); Lars DALSGAARD, Oulu (FI)

(21) Appl. No.: 18/758,003

(22) Filed: Jun. 28, 2024

(30) Foreign Application Priority Data
Aug. 7, 2023 (WO) PCT/CN2023/111576

(51) Int. Cl. H04W 76/28; H04L 5/00; H04W 24/08

(52) U.S. Cl. CPC H04W 76/28; H04L 5/0051; H04W 24/08

(57) ABSTRACT

The present disclosure relates to a first cell activation when the cell discontinuous transmission (DTX)/discontinuous reception (DRX) is applied. In particular, a network device transmits a configuration of cell DTX and/or a configuration of cell DRX for a first cell to a terminal device. The network device also transmits an activation indication for the first cell. The terminal device monitors a set of reference signals from the network device during an activation procedure of the first cell. The terminal device further transmits a report that is based on a measurement on the set of reference signals to a cell that is a special cell or a physical uplink control channel cell. In this way, it can reduce the latency of the activation of the first cell.

### CROSS REFERENCE TO RELATED APPLICATION

This application claims the benefit of International Patent Application No. PCT/CN2023/111576, filed Aug. 7, 2023. The entire content of the above-referenced application is hereby incorporated by reference.

### FIELDS

Various example embodiments of the present disclosure generally relate to the field of telecommunication and in particular, to methods, devices, apparatuses and computer readable storage medium for cell activation.

### BACKGROUND

Network energy saving (NES) is a hot topic in communication field. For example, cell DTX/DRX is also proposed at network device side in order to save power at the network device. Similarly, cell DTX/DRX is a technique that allows the network device to sleep within a DTX/DRX cycle when there are no packets to be transmitted/received. However, it is not clear how the terminal device and network device behave when the cell DTX/DRX and other techniques are applied simultaneously.

### SUMMARY

In a first aspect of the present disclosure, there is provided an apparatus. The apparatus comprises at least one processor; and at least one memory storing instructions that, when executed by the at least one processor, cause the apparatus to: receive, from a network device, a configuration of a first cell, wherein the configuration comprises at least one of: a configuration of a cell discontinuous transmission for the first cell or a configuration of a cell discontinuous reception for the first cell; receive, from the network device, an activation indication for the first cell; and monitor a set of reference signals from the network device during an activation procedure of the first cell.

In a second aspect of the present disclosure, there is provided an apparatus. The apparatus comprises at least one processor; and at least one memory storing instructions that, when executed by the at least one processor, cause the apparatus to: transmit, to a terminal device, a configuration of a first cell, wherein the configuration comprises at least one of: a configuration of a cell discontinuous transmission for the first cell or a configuration of a cell discontinuous reception for the first cell; transmit, to the terminal device, an activation indication for the first cell; and transmit a set of reference signals to the terminal device during an activation procedure of the first cell.

In a third aspect of the present disclosure, there is provided a method. The method comprises: receiving, from a network device, a configuration of a first cell, wherein the configuration comprises at least one of: a configuration of a cell discontinuous transmission for the first cell or a configuration of a cell discontinuous reception for the first cell; receiving, from the network device, an activation indication for the first cell; and monitoring a set of reference signals from the network device during an activation procedure of the first cell.

In a fourth aspect of the present disclosure, there is provided a method. The method comprises: transmitting, to a terminal device, a configuration of a first cell, wherein the configuration comprises at least one of: a configuration of a cell discontinuous transmission for the first cell or a configuration of a cell discontinuous reception for the first cell; transmitting, to the terminal device, an activation indication for the first cell; and transmitting a set of reference signals to the terminal device during an activation procedure of the first cell.

In a fifth aspect of the present disclosure, there is provided a first apparatus. The first apparatus comprises means for receiving, from a network device, a configuration of a first cell, wherein the configuration comprises at least one of: a configuration of a cell discontinuous transmission for the first cell or a configuration of a cell discontinuous reception for the first cell; means for receiving, from the network device, an activation indication for the first cell; and means for monitoring a set of reference signals from the network device during an activation procedure of the first cell.

In a sixth aspect of the present disclosure, there is provided a second apparatus. The second apparatus comprises means for transmitting, to a terminal device, a configuration of a first cell, wherein the configuration comprises at least one of: a configuration of a cell discontinuous transmission for the first cell or a configuration of a cell discontinuous reception for the first cell; means for transmitting, to the terminal device, an activation indication for the first cell; and means for transmitting a set of reference signals to the terminal device during an activation procedure of the first cell.

In a seventh aspect of the present disclosure, there is provided a computer readable medium. The computer readable medium comprises instructions stored thereon for causing an apparatus to perform at least the method according to the third aspect.

In an eighth aspect of the present disclosure, there is provided a computer readable medium. The computer readable medium comprises instructions stored thereon for causing an apparatus to perform at least the method according to the fourth aspect.

It is to be understood that the Summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, where:

FIG. 1 illustrates an example communication environment in which example embodiments of the present disclosure can be implemented;

FIG. 2 illustrates a signaling chart for cell DTX/DRX according to example embodiments of the present disclosure;

FIG. 3 illustrates a schematic diagram of cell DTX/DRX according to example embodiments of the present disclosure;

FIG. 4A and FIG. 4B illustrate schematic diagrams of cell DTX/DRX according to example embodiments of the present disclosure, respectively;

FIG. 5 illustrates a flowchart of a method implemented at a first device according to some example embodiments of the present disclosure;

FIG. 6 illustrates a flowchart of a method implemented at a second device according to some example embodiments of the present disclosure;

FIG. 7 illustrates a simplified block diagram of a device that is suitable for implementing example embodiments of the present disclosure; and

FIG. 8 illustrates a block diagram of an example computer readable medium in accordance with some example embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. Embodiments described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first,” “second,” . . . , etc. in front of noun(s) and the like may be used herein to describe various elements, these elements should not be limited by these terms. These terms are only used to distinguish one element from another and they do not limit the order of the noun(s). For example, a first element could be termed a second element, and similarly, a second element could be termed a first element, without departing from the scope of example embodiments. As used herein, the term “and/or” includes any and all combinations of one or more of the listed terms.

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

As used herein, unless stated explicitly, performing a step “in response to A” does not indicate that the step is performed immediately after “A” occurs and one or more intervening steps may be included.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as New Radio (NR), Long Term Evolution (LTE), LTE-Advanced (LTE-A), Wideband Code Division Multiple Access (WCDMA), High-Speed Packet Access (HSPA), Narrow Band Internet of Things (NB-IoT) and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the fifth generation (5G), the sixth generation (6G) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), an NR NB (also referred to as a gNB), a Remote Radio Unit (RRU), a radio header (RH), a remote radio head (RRH), a relay, an Integrated Access and Backhaul (IAB) node, a low power node such as a femto, a pico, a non-terrestrial network (NTN) or non-ground network device such as a satellite network device, a low earth orbit (LEO) satellite and a geosynchronous earth orbit (GEO) satellite, an aircraft network device, and so forth, depending on the applied terminology and technology. In some example embodiments, radio access network (RAN) split architecture comprises a Centralized Unit (CU) and a Distributed Unit (DU) at an IAB donor node. An IAB node comprises a Mobile Terminal (IAB-MT) part that behaves like a UE toward the parent node, and a DU part of an IAB node behaves like a base station toward the next-hop IAB node.

The term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VoIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. The terminal device may also correspond to a Mobile Termination (MT) part of an IAB node (e.g., a relay node). In the following description, the terms “terminal device”, “communication device”, “terminal”, “user equipment” and “UE” may be used interchangeably.

As used herein, the term “resource,” “transmission resource,” “resource block,” “physical resource block” (PRB), “uplink resource,” or “downlink resource” may refer to any resource for performing a communication, for example, a communication between a terminal device and a network device, such as a resource in time domain, a resource in frequency domain, a resource in space domain, a resource in code domain, or any other combination of the time, frequency, space and/or code domain resource enabling a communication, and the like. In the following, unless explicitly stated, a resource in both frequency domain and time domain will be used as an example of a transmission resource for describing some example embodiments of the present disclosure. It is noted that example embodiments of the present disclosure are equally applicable to other resources in other domains.

As used herein, the term “primary cell (PCell)” may refer to a cell in MCG that operates on a primary frequency in which the terminal device either performs an initial connection establishment procedure or initiates the connection re-establishment procedure. The term “secondary cell (SCell)” used herein may refer to for the terminal device configured with a carrier aggregation (CA), a cell providing addition radio resources. For Dual Connectivity operation the term “special cell (SpCell)” refers to the PCell of the MCG or the PSCell of the SCG depending on if a medium access control (MAC) entity is associated to the MCG or the SCG, respectively. Otherwise, the term “SpCell” may refer to the PCell. A SpCell may support a physical uplink control channel (PUCCH) transmission and a contention-based random access.

As used herein, the term “RRC connected state” or “RRC connected mode” used herein may refer to a state in which service radio bearer and data radio bearer are allocated for the terminal device. The term “RRC idle state” or “RRC idle mode” used herein may refer to a state where the terminal device is switched on but does not have any established RRC connection. The term “RRC inactive state” or “RRC inactive mode” used herein may refer to a state when there is an RRC connection that has been suspended.

As used herein, the term “cell discontinuous reception (DRX)” used herein may refer to a technique that allows a network device to receive data or sleep within a period. The term “cell discontinuous transmission (DTX)” used herein refers to a technique that allows the network device to transmit data or sleep within a period. The cell DRX/DTX can be used in mobile communication to conserve the battery of the network device. The term “on duration” or “active period” used for cell DRX refers to a time period during which the network device is able to monitor a channel, for example, a physical control channel or a physical shared channel, and receive data or control information on the channel. The term “DRX period” or “opportunity for DRX” or “off time” or “off duration” or “non-active/inactive period” used for cell DRX refers to a time period during which the network device does not monitor the channel and does not receive data or control information on the channel. The term “DRX cycle” used herein comprises an on-duration during which the network device may monitor the channel and a DRX period during which the network device can skip reception of channel. The term “on duration” or “active period” used for cell DTX refers to a time period during which the network device is able to transmit data or control information on a channel, for example, a physical control channel or a physical shared channel. The term “DTX period” or “opportunity for DTX” or “off time” or “off duration” or “non-active/inactive period” for cell DTX used herein refers to a time period during which the network device does not transmit data or control information on the channel. The term “DTX cycle” used herein comprises an on-duration during which the network device may transmit data or control information on the channel and a DTX period during which the network device can skip transmission of channel. The term “DRX cycle” used herein comprises an on-duration during which the network device may receive data or control information on the channel and a DRX period during which the network device can skip reception of channel.

The term “an activation of a cell” used herein may refer to a procedure there is a transmission via cell radio link control (RLC) bearers. The term “a deactivation of a cell” used herein may refer to a procedure where there is no transmission via cell radio link control (RLC) bearers. Herein the activation of a cell may include the activation of SCell and/or the activation of PSCell.

As mentioned above, the cell DTX/DRX is proposed. For example, it has been agreed cell DTX/DRX can be configured per serving cell with radio resource control (RRC) signaling and activated/deactivated with layer 1 (L1)/layer 2 (L2) signaling, as well as UE and gNB behavior during the cell DTX/DRX active and non-active period. For example, the UE is not expected to receive and/or process the periodic or semi-persistent channel state information reference signal (CSI-RS) from the gNB, during non-active periods of cell DTX. In other words, the network device may omit it during non-active period for energy saving.

In case of carrier aggregation, an SCell can be activated/deactivated with SCell Activation/Deactivation medium access control (MAC) control elements (CEs) or Enhanced SCell Activation/Deactivation MAC CEs and different requirements have been defined for how long the UE needs to be able to activate an SCell from deactivated state based on the configuration of available reference signals (e.g. synchronization signal/physical broadcast channel block (PBCH) (SSB) and/or CSI-RS) for synchronization and measurement, and depending on whether the SCell Activation/Deactivation MAC CEs is used or the Enhanced SCell Activation/Deactivation MAC CEs with tracking reference signal (TRS) indicated. However, there is no discussion of interaction between Cell DTX/DRX and cell activation (for example, SCell activation or PSCell activation).

Embodiments of the present disclosure relate to cell activation when the cell DTX/DRX is applied. In particular, a network device transmits a configuration of cell DTX and/or a configuration of cell DRX for a first cell to a terminal device. The network device also transmits an activation indication for the first cell. The terminal device monitors a set of reference signals from the network device during an activation procedure of the first cell. In this way, it can reduce the latency of the activation of the SCell.

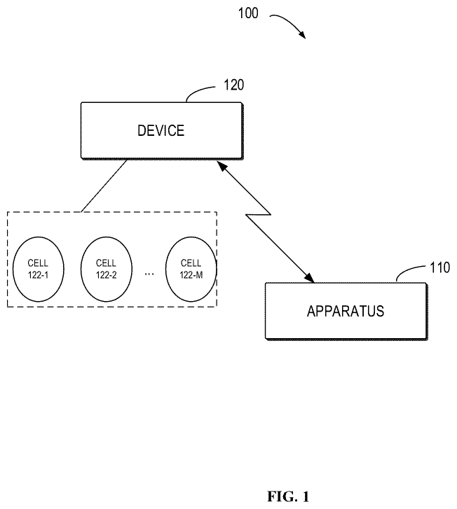

FIG. 1 illustrates an example communication environment 100 in which example embodiments of the present disclosure can be implemented. In the communication environment 100, a first device 110 and a second device 120 may communicate with each other.

The first device 110 may be a terminal device, such as a UE. The second device 120 may be a network device, such as gNBs. The second device 120 may provide one or more of cells, which may include one cell 122-1 or a plurality of cells 122-1 to 122-M, where the cell 122-1 may be the PCell, while the rest of the cells may be SCells. M may be a suitable integer number.

In the following, for the purpose of illustration, some example embodiments are described with the first device 110 operating as a terminal device and the second device 120 operating as a network device. However, in some example embodiments, operations described in connection with a terminal device may be implemented at a network device or other device, and operations described in connection with a network device may be implemented at a terminal device or other device.

In some example embodiments, if the first device 110 is a terminal device and the second device 120 is a network device, a link from the second device 120 to the first device 110 is referred to as a downlink (DL), and a link from the first device 110 to the second device 120 is referred to as an uplink (UL). In DL, the second device 120 is a transmitting (TX) device (or a transmitter) and the first device 110 is a receiving (RX) device (or a receiver). In UL, the first device 110 is a TX device (or a transmitter) and the second device 120 is a RX device (or a receiver).

Communications in the communication environment 100 may be implemented according to any proper communication protocol(s), comprising, but not limited to, cellular communication protocols of the first generation (1G), the second generation (2G), the third generation (3G), the fourth generation (4G), the fifth generation (5G), the sixth generation (6G), and the like, wireless local network communication protocols such as Institute for Electrical and Electronics Engineers (IEEE) 802.11 and the like, and/or any other protocols currently known or to be developed in the future. Moreover, the communication may utilize any proper wireless communication technology, comprising but not limited to: Code Division Multiple Access (CDMA), Frequency Division Multiple Access (FDMA), Time Division Multiple Access (TDMA), Frequency Division Duplex (FDD), Time Division Duplex (TDD), Multiple-Input Multiple-Output (MIMO), Orthogonal Frequency Division Multiple (OFDM), Discrete Fourier Transform spread OFDM (DFT-s-OFDM) and/or any other technologies currently known or to be developed in the future.

Example embodiments of the present disclosure will be described in detail below with reference to the accompanying drawings.

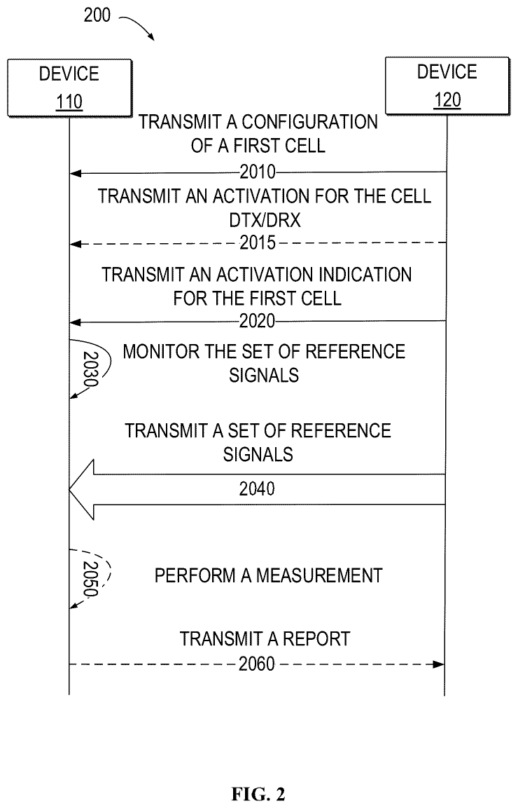

Reference is made to FIG. 2, which illustrates a signaling flow 200 in accordance with some embodiments of the present disclosure. For the purposes of discussion, the signaling flow 200 will be discussed with reference to FIG. 1, for example, by using the first device 110, the second device 120. Only for the purpose of illustrations, the cell 122-1 is described as the primary secondary cell and the cell 122-2 is described as the secondary cell.

The second device 120 transmits (2010) a configuration of a cell (also referred to as “first cell”) (for example, the cell 122-1 or the cell 122-2) to the first deice 110. In other words, the first device 110 receives the configuration of the first cell from the second device 120. The configuration includes one or more of: a configuration of cell DTX for the first cell or a configuration of cell DRX for the cell. In some example embodiments, the configuration of the first cell may be transmitted via a RRC signaling.

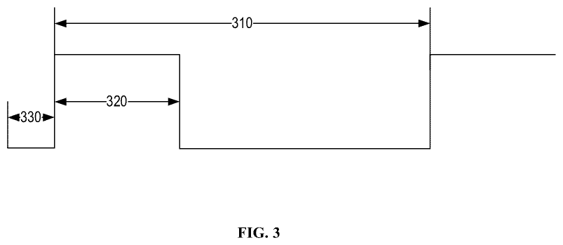

The configuration may indicate a periodicity of the cell DTX or cell DRX. The configuration may also indicate an on duration for the cell DTX or cell DRX. In addition, the configuration may indicate an offset of the on duration of the cell DTX or cell DRX. Only for the purpose of illustrations, FIG. 3 an example of the configuration of cell DTX. For example, as shown in FIG. 3, the configuration of cell DTX may indicate a periodicity 310 of the cell DTX. The configuration of cell DTX may also indicate an on duration 320 of the cell DTX within which the second device 120 may transmit data and/or control information. Further, the configuration of cell DTX may indicate the offset 330 that indicates a start slot of the cell DTX.

In some example embodiments, the second device 120 may transmit (2015) an activation of the cell DTX or cell DRX to the first device 110. In other words, the first device 110 may receive the activation of the cell DTX or cell DRX from the second device 120. For example, the activation of the cell DTX or cell DRX may be transmitted using a layer 1 (L1) signaling to activate the cell DTX operation.

The second device 120 transmits (2020) an activation indication for the first cell to the first device 110. In other words, the first device 110 receives the activation indication for the first cell from the second device 120. In some example embodiments, the activation indication may be used for activating the cell 122-1 that is the PSCell. Alternatively, the activation indication may be used for activating the cell 122-2 that is the SCell. For example, the second device 120 may transmit an activation command (for example, a MAC command SCell/PSCell activation command or SCG activation command) to the first device 110 based on deciding to activate the SCell. In some other example embodiments, the activation indication for the first cell (for example, PSCell 122-1 or the SCell 122-1) may be transmitted in an RRC reconfiguration message. Only for the purpose of illustrations, SCell activation is taken as an example in the following description. It is noted that embodiments described below can also be applied to PSCell activation.

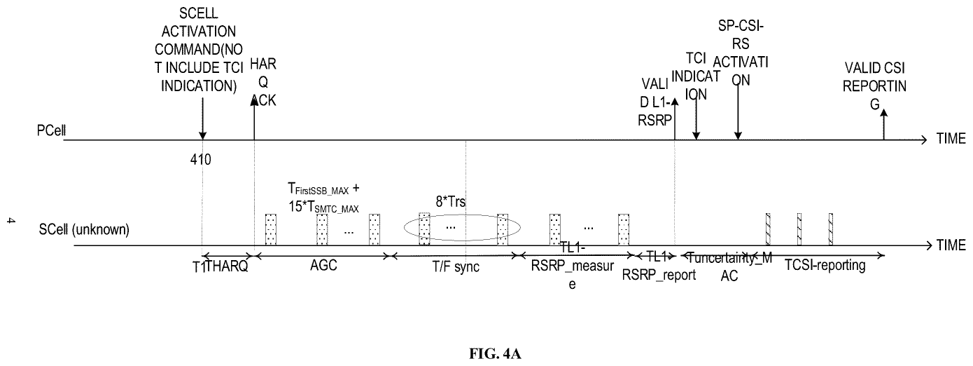

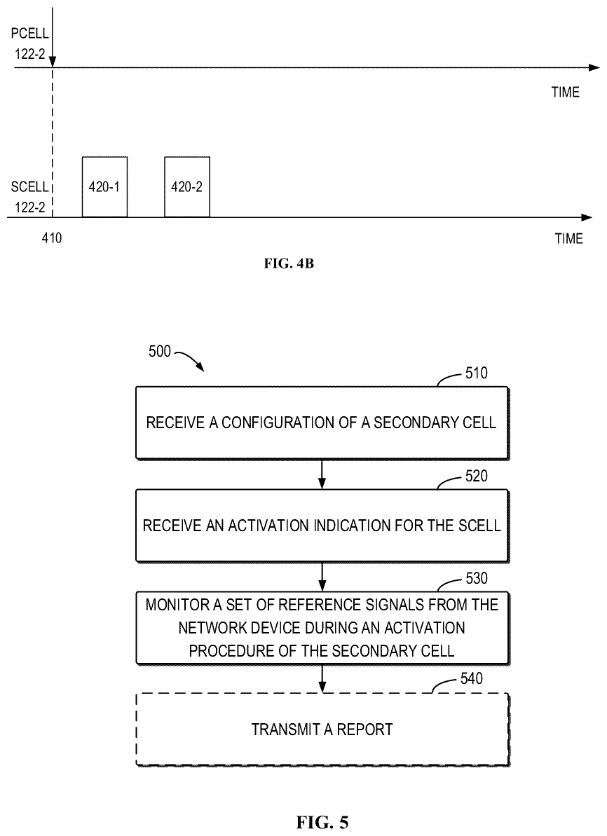

After receiving the activation indication, the first device 110 may perform a first cell activation procedure. For example, as shown in FIG. 4A, after receiving the activation indication at a time instant 410, the first device 110 may be expected to perform an automatic gain control (AGC), a time and frequency synchronization, a L1-reference signal received power (RSRP) measurement and a CSI measurement in order to activate the SCell 122-2. In particular, the CSI measurement may be based on the semi-persistent/persistent (SP/P)-CSI-RS configured for channel measurement and the first device 110 may transmit a valid CSI report as the ending point of SCell activation procedure. In some example embodiments, upon receiving the SCell activation command in slot n, the first device 110 may be capable to transmit the valid CSI report and apply actions related to the activation command for the SCell being activated no later than in slot

$$n + \frac{{T}_{HARQ} + {T}_{activation \_ time} + {T}_{CSI \_ Reporting}}{NR slot length} .$$

The first device 110 monitors (2030) a set of reference signals from the second device 120 during an activation procedure of the first cell (for example, SCell 122-2). For example, as shown in FIG. 4B, after the reception of the activation indication at the time instant 410, the first device 110 may monitor the set of reference signals on one or more monitoring occasions 420-1 and 420-2. The second device 120 transmits (2030) the set of reference signals to the first device 110. In other words, the first device 110 receives the set of reference signals from the second device 120. In this way, it can minimize the impact of cell DTX/DRX on the SCell activation delay.

In some example embodiments, the first device 110 may determine that the cell discontinuous transmission for the first cell (for example, SCel 122-2) is deactivated based on the reception of the activation indication for the first cell. For example, upon reception of the SCell activation command, the Cell DTX/DRX for the SCell 122-2 may be automatically/implicitly deactivated. In other words, the first device 110 may autonomously deactivate the cell discontinuous transmission for the first cell upon the activation of the first cell without separate command to deactivate the cell discontinuous transmission from the second device 120. The second device 120 deactivate the cell discontinuous transmission for the first cell upon the activation of the first cell.

Alternatively, the configuration may also include a configuration of a further DTX. In this case, in some embodiments, after receiving the activation indication of the first cell, the first device 110 may switch from the cell DTX to the further cell DTX. For example, if more than one cell DTX/DRX patterns are supported, upon the reception of the SCell activation command, the Cell DTX/DRX of SCell may be switched to another cell DTX pattern. The other cell DTX pattern may be configured by the second device 120 for better catering for SCell activation procedure.

After activation procedure of the first cell, the second device 120 may transmit an activation indication for the cell DTX for the first cell to the first device 110. In this case, after receiving the activation indication for the cell DTX for the first cell, the first device 110 may determine that the cell DTX for the first cell is activated based on the activation indication for the cell DTX. In other words, the activation of the cell DTX after the activation of the first cell may be explicitly indicated by the second device 120. Alternatively, activation of the cell DTX after the activation of the first cell may be implicitly indicated by the second device 120. In some other example embodiments, the first device 120 may determine that the cell DTX for the first cell is activated based on a timer after the activation procedure of the first cell. Alternatively, the first device 120 may determine that the cell DTX for the first cell is activated after the activation procedure of the first cell (i.e., without the timer).

In some example embodiments, the second device 120 may transmit the set of reference signals regardless of a non-active period of the cell DTX during the activation procedure of the first cell. In other words, the first device 110 may receive the set of reference signals regardless of a non-active period of the cell DTX during the activation procedure of the first cell. For example, the set of reference signals (such as, periodic/semi-persistence CSI) may be transmitted or available for the CSI measurement regardless of the cell DTX non-active period during a cell activation period, without explicit deactivation indication of the cell DTX/DRX.

In some other example embodiments, the set of reference signals may be a set of tracking reference signals or CSI-RS indicated in the activation indication. In this case, in some example embodiments, the second device 120 may transmit the set of tracking reference signals in a non-active period of the cell DTX during the activation procedure of the first cell. In other words, the first device 110 may receive the set of tracking reference signals in a non-active period of the cell DTX during the activation procedure of the first cell. The first device 110 may perform the measurement on the set of tracking reference signals. For example, the set of tracking reference signals indicated in an enhanced SCell activation/deactivation medium access control (MAC) control element (CE) can be sent by the second device 120 even if it is in the cell DTX non-active period, so that the first device 110 can perform the synchronization and measurement based on the set of tracking reference signals during the activation procedure of the first cell.

In an example embodiment, the first device 110 may determine that an active period of the cell DTX is extended during the activation procedure of the first cell. For example, the active period of cell DTX/DRX for the SCell 122-2 being activated can be extended for the first device 110 during the period of the SCell activation. By way of example, the active period of cell DTX/DRX may be extended until the first device 110 transmits a valid CSI report of the first device 110 completes the SCell activation procedure.

In another example embodiment, the second device 120 may transmit a deactivation indication of the cell DTX. In other words, the first device 110 may receive the deactivation indication of the cell DTX from a serving cell. In this case, the first device 110 may determine that the cell DTX is deactivated before the reception of the activation indication for the first cell. For example, the deactivation indication may be transmitted in downlink control information (DCI). Alternatively, the deactivation indication may be transmitted in a MAC CE. For example, the cell DTX/DRX can be activated/deactivated with cross carrier indication in the DCI or MAC CE, so that the cell DTX/DRX can be deactivated from other activated serving cells before the second device 120 sending (2020) the activation indication to activate the first cell.

Referring back to FIG. 2, the first device 110 may measure (2050) a measurement based on the set of reference signals. For example, the first device 110 may perform a CSI measurement on the set of reference signals.

The first device 110 may transmits (2060) a report that is based on a measurement on the set of reference signals to another cell (also referred to as “second cell”) that is a special cell or a physical uplink control channel cell. In other words, the second device 120 receives the report from the first device 110. In some example embodiments, the second cell may be a SpCell. Alternatively, the second cell may be a PUCCH SCell. In one example, if the SCell being activated is a downlink only SCell not configured with PUCCH, the first device 110 transmits (2060) a report on PCell or PSCell. If the if the SCell being activated is PUCCH SCell which is configured with PUCCH, the first device 110 transmits (2060) a report on PUCCH SCell itself. In some example embodiments, if the first cell is a SCell, the second cell is the PCell or PSCell which is different from the first cell. Alternatively, if the first cell is a PUCCH cell, the first cell and the second cell are the same cell.

In some example embodiments, if the report is configured to be transmitted, the first device 110 may determine that a cell DRX of the second cell is deactivated. For example, the cell DTX/DRX may be implicitly deactivated on the second cell (i.e., SpCell or PUCCH SCell) where the CSI reporting of the SCell 122-2 being activated is configured to reported.

In some other example embodiments, the first device 110 may transmit the report regardless of a non-active period of a cell DRX of the second cell where the CSI reporting of the first cell (for example, the SCell 122-2) being activated is configured to reported, during the activation procedure of the first cell. In other words, the second device 120 may receive the report regardless of a non-active period of a cell DRX of the cell during the activation procedure of the first cell (for example, the SCell 122-2). For example, during the SCell activation period, CSI reporting for the SCell being activated can be transmitted regardless of the SpCell or PUCCH SCell for CSI reporting for the SCell is in active period or not, until Non-out of range (OoR)/valid value is transmitted.

Alternatively, at least one valid report may be allowed to be transmitted regardless of a non-active period of a cell DRX of the second cell during the activation procedure of the first cell (for example, SCell 122-2). For example, at least the valid CSI report may be allowed to be transmitted regardless of the cell DRX non-active period of the second cell where the CSI reporting of the SCell 122-2 being activated is configured to reported during Scell activation phase (i.e., the CSI report with Non-OoR/invalid value can still be transmitted during Cell DRX active periods only). The CSI report with OoR value for the SCell can be omitted.

In some other example embodiments, the first device 110 may determine that an active period of a cell DRX of the second cell is extended until the CSI report is received by the second device 120. For example, the cell DTX/DRX active period may be extended for the SpCell or PUCCH SCell for CSI reporting for the SCell being activated until a valid CSI reporting is received.

In another example embodiment, the second device 120 may transmit a deactivation indication of the cell DRX for the second cell where the CSI reporting of the first cell being activated is configured to reported. In other words, the first device 110 may receive the deactivation indication of the cell DRX for the cell from a serving cell. In this case, the first device 110 may determine that the cell DRX needs to be deactivated before the reception of the activation indication for the SCell 122-2. For example, the deactivation indication may be transmitted in downlink control information (DCI). Alternatively, the deactivation indication may be transmitted in a MAC CE. For example, the second device 120 may deactivate the cell DTX/DRX of the second cell (i.e., the SpCell or PUCCH SCell for CSI reporting for the SCell being activated) before the second device 120 sending (2020) the activation indication to activate the first cell (for example, SCell 122-2).

According to embodiments described with reference to FIG. 2, it can keep reference signaling for measurement or synchronization and CSI report during Cell DRX/DTX work properly, or in other words the cell activation procedure is not impacted or delayed by the non-active periods of cell DTX/DRX. In this way, it can ensure the CSI report during cell DTX/DRX can be report right on time, thereby reducing the cell activation delay.

FIG. 5 shows a flowchart of an example method 500 implemented at a first device in accordance with some example embodiments of the present disclosure. For the purpose of discussion, the method 500 will be described from the perspective of the first device 110 in FIG. 1.

At block 510, the first device 110 receives, from a network device, a configuration of a first cell. The configuration comprises at least one of: a configuration of a cell discontinuous transmission for the first cell or a configuration of a cell discontinuous reception for the first cell.

At block 520, the first device 110 receives, from the network device, an activation indication for the first cell.

At block 530, the first device 110 monitors a set of reference signals from the network device during an activation procedure of the first cell.

In some example embodiments, the method 500 further comprises: determining that the cell discontinuous transmission for the first cell is deactivated based on the reception of the activation indication for the first cell.

In some example embodiments, the method 500 further comprises: receiving, from the network device, an activation indication for the cell discontinuous transmission for the first cell; and determining that the cell discontinuous transmission for the first cell is activated based on the activation indication for the cell discontinuous transmission for the first cell.

In some example embodiments, the method 500 further comprises: determining that the cell discontinuous transmission for the first cell is activated based on a timer after the activation procedure of the first cell. Alternatively, the method 500 further comprises: determining that the cell discontinuous transmission for the first cell is activated after the activation procedure of the first cell.

In some example embodiments, the method 500 further comprises: in accordance with a determination that the configuration also comprises a configuration of a further cell discontinuous transmission, determining to switch from the cell discontinuous transmission to the further cell discontinuous transmission.

In some example embodiments, the method 500 further comprises: receiving, from the network device, the set of reference signals regardless of a non-active period of the cell discontinuous transmission during the activation procedure of the first cell.

In some example embodiments, the method 500 further comprises: receiving the set of tracking reference signals in a non-active period of the cell discontinuous transmission during the activation procedure of the first cell; and performing the measurement on the set of tracking reference signals.

In some example embodiments, the method 500 further comprises: determining that an active period of the cell discontinuous transmission is extended during the activation procedure of the first cell, until a valid report is transmitted by the first device 110.

In some example embodiments, the method 500 further comprises: receiving a deactivation indication of the cell discontinuous transmission from a serving cell; and determining that the cell discontinuous transmission is deactivated before the reception of the activation indication for the first cell.

In some example embodiments, at block 540, the first device 110 may transmit a report that is based on a measurement on the set of reference signals to a second cell that is a special cell or a physical uplink control channel cell.

In some example embodiments, the method 500 further comprises: determining that a cell discontinuous reception of the physical uplink control channel secondary cell is deactivated when the first cell is a secondary cell configured with physical uplink control channel; or determining that a cell discontinuous reception of the special cell is deactivated when the first cell is a secondary cell not configured with physical uplink control channel.

In some example embodiments, the method 500 further comprises: in accordance with a determination that the report is configured to be transmitted, determining that a cell discontinuous reception of the second cell is deactivated.

In some example embodiments, the method 500 further comprises: transmitting the

report regardless of a non-active period of a cell discontinuous reception of the second cell during the activation procedure of the first cell.

In some example embodiments, at least one valid report is allowed to be transmitted regardless of a non-active period of a cell discontinuous reception of the second cell during the activation procedure of the first cell.

In some example embodiments, the method 500 further comprises: determining that an active period of a cell discontinuous reception of the second cell is extended until the report is received by the network device.

In some example embodiments, the method 500 further comprises: receiving a deactivation indication of a cell discontinuous reception of the second cell from a serving cell; and determining that a cell discontinuous reception of the second cell is deactivated before the reception of the activation indication for the first cell.

In some example embodiments, the method 500 further comprises: receiving, from the network device, an activation indication of the cell discontinuous reception or the cell discontinuous transmission.

In some example embodiments, the apparatus comprises a terminal device.

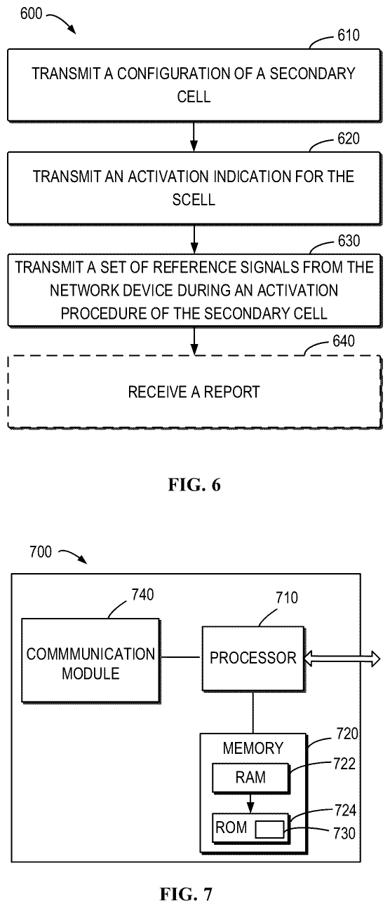

FIG. 6 shows a flowchart of an example method 600 implemented at a second device in accordance with some example embodiments of the present disclosure. For the purpose of discussion, the method 600 will be described from the perspective of the second device 120 in FIG. 1.

At block 610, the second device 120 transmits, to a terminal device, a configuration of a first cell. The configuration comprises at least one of: a configuration of a cell discontinuous transmission for the first cell or a configuration of a cell discontinuous reception for the first cell.

At block 620, the second device 120 transmits, to the terminal device, an activation indication for the first cell.

At block 630, the second device 120 transmits a set of reference signals to the terminal device during an activation procedure of the first cell.

In some example embodiments, the method 600 further comprises: deactivating the cell discontinuous transmission for the first cell based on the activation indication for the first cell.

In some example embodiments, the method 600 further comprises: transmitting, to the terminal device, an activation indication for the cell discontinuous transmission for the first cell.

In some example embodiments, the method 600 further comprises: activating the cell discontinuous transmission for the first cell based on a timer after the activation procedure of the first cell. Alternatively, the method 600 further comprises: activating the cell discontinuous transmission for the first cell after the activation procedure of the first cell.

In some example embodiments, the method 600 further comprises: switching from the cell discontinuous transmission to a further cell discontinuous transmission.

In some example embodiments, the method 600 further comprises: transmitting, to the terminal device, the set of reference signals regardless of a non-active period of the cell discontinuous transmission during the activation procedure of the first cell.

In some example embodiments, the method 600 further comprises: transmitting the set of tracking reference signals in a non-active period of the cell discontinuous transmission during the activation procedure of the first cell.

In some example embodiments, the method 600 further comprises: extending an active period of the cell discontinuous transmission during the activation procedure of the first cell, until a valid report is received by the apparatus.

In some example embodiments, the method 600 further comprises: transmitting a deactivation indication of the cell discontinuous transmission to the terminal device; and deactivating the cell discontinuous transmission before the activation indication for the first cell.

In some example embodiments, at block 640, the second device 120 receives, from the terminal device, a report that is based on a measurement on the set of reference signals to a cell that is a special cell or a physical uplink control channel cell.

In some example embodiments, a cell discontinuous reception of the physical uplink control channel secondary cell is deactivated when the first cell is a secondary cell configured with physical uplink control channel or a cell discontinuous reception of the special cell is deactivated when the first cell is a secondary cell not configured with physical uplink control channel.

In some example embodiments, the method 600 further comprises: in accordance with a determination that the report is configured to be received, deactivating a cell discontinuous reception of the second cell.

In some example embodiments, the method 600 further comprises: receiving the report regardless of a non-active period of a cell discontinuous reception of the cell during the activation procedure of the first cell.

In some example embodiments, at least one valid report is allowed to be received regardless of a non-active period of a cell discontinuous reception of the second cell during the activation procedure of the first cell.

In some example embodiments, the method 600 further comprises: extending an active period of a cell discontinuous reception of the second cell until the report is received by the apparatus.

In some example embodiments, the method 600 further comprises: transmitting a deactivation indication of a cell discontinuous reception of the second cell to the terminal device; and deactivating a cell discontinuous reception of the second cell before the reception of the activation indication for the first cell.

In some example embodiments, the method 600 further comprises: transmitting, to a terminal device, an activation indication of the cell discontinuous transmission or the cell discontinuous reception.

In some example embodiments, the apparatus comprises a network device.

In some example embodiments, a first apparatus capable of performing any of the method 500 (for example, the first device 110 in FIG. 1) may comprise means for performing the respective operations of the method 500. The means may be implemented in any suitable form. For example, the means may be implemented in a circuitry or software module. The first apparatus may be implemented as or included in the first device 110 in FIG. 1.

In some example embodiments, the first apparatus comprises means for receiving, from a network device, a configuration of a first cell, wherein the configuration comprises at least one of: a configuration of a cell discontinuous transmission for the first cell or a configuration of a cell discontinuous reception for the first cell; means for receiving, from the network device, an activation indication for the first cell; and means for monitoring a set of reference signals from the network device during an activation procedure of the first cell.

In some example embodiments, the first apparatus further comprises: means for determining that the cell discontinuous transmission for the first cell is deactivated based on the reception of the activation indication for the first cell.

In some example embodiments, the first apparatus further comprises: means for receiving, from the network device, an activation indication for the cell discontinuous transmission for the first cell; and means for determining that the cell discontinuous transmission for the first cell is activated based on the activation indication for the cell discontinuous transmission for the first cell.

In some example embodiments, the first apparatus further comprises: means for determining that the cell discontinuous transmission for the first cell is activated based on a timer after the activation procedure of the first cell.

In some example embodiments, the first apparatus further comprises: means for determining that the cell discontinuous transmission for the first cell is activated after the activation procedure of the first cell.

In some example embodiments, the first apparatus further comprises: means for in accordance with a determination that the configuration also comprises a configuration of a further cell discontinuous transmission, determining to switch from the cell discontinuous transmission to the further cell discontinuous transmission.

In some example embodiments, the first apparatus further comprises: means for receiving, from the network device, the set of reference signals regardless of a non-active period of the cell discontinuous transmission during the activation procedure of the first cell.

In some example embodiments, the set of reference signals is a set of tracking reference signals indicated in the activation indication, and wherein the first apparatus further comprises: means for receiving the set of tracking reference signals in a non-active period of the cell discontinuous transmission during the activation procedure of the first cell; and means for performing the measurement on the set of tracking reference signals.

In some example embodiments, the first apparatus further comprises: means for determining that an active period of the cell discontinuous transmission is extended during the activation procedure of the first cell, until a valid report is transmitted by the first apparatus.

In some example embodiments, the first apparatus further comprises: means for receiving a deactivation indication of the cell discontinuous transmission from a serving cell; and means for determining that the cell discontinuous transmission is deactivated before the reception of the activation indication for the first cell.

In some example embodiments, the first apparatus further comprises: means for transmitting a report that is based on a measurement on the set of reference signals to a second cell that is a special cell or a physical uplink control channel cell.

In some example embodiments, the first apparatus further comprises: means for in accordance with a determination that the report is configured to be transmitted, determining that a cell discontinuous reception of the second cell is deactivated.

In some example embodiments, the first apparatus further comprises: means for determining that a cell discontinuous reception of the physical uplink control channel secondary cell is deactivated when the first cell is a secondary cell configured with physical uplink control channel or means for determining that a cell discontinuous reception of the special cell is deactivated when the first cell is a secondary cell not configured with physical uplink control channel.

In some example embodiments, the first apparatus further comprises: means for transmitting the report regardless of a non-active period of a cell discontinuous reception of the second cell during the activation procedure of the first cell.

In some example embodiments, at least one valid report is allowed to be transmitted regardless of a non-active period of a cell discontinuous reception of the second cell during the activation procedure of the first cell.

In some example embodiments, the first apparatus further comprises: means for determining that an active period of a cell discontinuous reception of the second cell is extended until the report is received by the network device.

In some example embodiments, the first apparatus further comprises: means for receiving a deactivation indication of a cell discontinuous reception of the second cell from a serving cell; and means for determining that a cell discontinuous reception of the second cell is deactivated before the reception of the activation indication for the first cell.

In some example embodiments, the first apparatus further comprises: means for receiving, from a network device, an activation indication of the cell discontinuous transmission or the cell discontinuous reception.

In some example embodiments, the first apparatus comprises a terminal device.

In some example embodiments, the first apparatus further comprises means for performing other operations in some example embodiments of the method 500 or the first device 110. In some example embodiments, the means comprises at least one processor; and at least one memory storing instructions that, when executed by the at least one processor, cause the performance of the first apparatus.

In some example embodiments, a second apparatus capable of performing any of the method 600 (for example, the second device 120 in FIG. 1) may comprise means for performing the respective operations of the method 600. The means may be implemented in any suitable form. For example, the means may be implemented in a circuitry or software module. The second apparatus may be implemented as or included in the second device 120 in FIG. 1.

In some example embodiments, the second apparatus comprises means for transmitting, to a terminal device, a configuration of a first cell, wherein the configuration comprises at least one of: a configuration of a cell discontinuous transmission for the first cell or a configuration of a cell discontinuous reception for the first cell; means for transmitting, to the terminal device, an activation indication for the first cell; and means for transmitting a set of reference signals to the terminal device during an activation procedure of the first cell.

In some example embodiments, the second apparatus further comprises: means for deactivating the cell discontinuous transmission for the first cell based on the activation indication for the first cell.

In some example embodiments, the second apparatus further comprises: means for transmitting, to the terminal device, an activation indication for the cell discontinuous transmission for the first cell.

In some example embodiments, the second apparatus further comprises: means for activating the cell discontinuous transmission for the first cell based on a timer after the activation procedure of the first cell.

In some example embodiments, the second apparatus further comprises: means for activating the cell discontinuous transmission for the first cell after the activation procedure of the first cell.

In some example embodiments, the second apparatus further comprises: means for switching from the cell discontinuous transmission to a further cell discontinuous transmission.

In some example embodiments, the second apparatus further comprises: means for transmitting, to the terminal device, the set of reference signals regardless of a non-active period of the cell discontinuous transmission during the activation procedure of the first cell.

In some example embodiments, the set of reference signals is a set of tracking reference signals indicated in the activation indication, and wherein the second apparatus further comprises: means for transmitting the set of tracking reference signals in a non-active period of the cell discontinuous transmission during the activation procedure of the first cell.

In some example embodiments, the second apparatus further comprises: means for extending an active period of the cell discontinuous transmission during the activation procedure of the first cell, until a valid report is received by the second apparatus.

In some example embodiments, the second apparatus further comprises: means for transmitting a deactivation indication of the cell discontinuous transmission to the terminal device; and means for deactivating the cell discontinuous transmission before the activation indication for the first cell. In some example embodiments, the second apparatus further comprises: means for receiving, from the terminal device, a report that is based on a measurement on the set of reference signals to a cell that is a special cell or a physical uplink control channel cell.

In some example embodiments, the second apparatus further comprises: means for in accordance with a determination that the report is configured to be received, deactivating a cell discontinuous reception of the second cell.

In some example embodiments, the second apparatus further comprises: means for deactivating a cell discontinuous reception of the physical uplink control channel secondary cell when the first cell is a secondary cell configured with physical uplink control channel; or means for deactivating a cell discontinuous reception of the special cell when the first cell is a secondary cell not configured with physical uplink control channel.

In some example embodiments, the second apparatus further comprises: means for receiving the report regardless of a non-active period of a cell discontinuous reception of the second cell during the activation procedure of the first cell.

In some example embodiments, at least one valid report is allowed to be received regardless of a non-active period of a cell discontinuous reception of the second cell during the activation procedure of the first cell.

In some example embodiments, the second apparatus further comprises: means for extending an active period of a cell discontinuous reception of the second cell until the report is received by the second apparatus.

In some example embodiments, the second apparatus further comprises: means for transmitting a deactivation indication of a cell discontinuous reception of the second cell to the terminal device; and means for deactivating a cell discontinuous reception of the second cell before the reception of the activation indication for the first cell.

In some example embodiments, the second apparatus further comprises: means for transmitting, to a terminal device, an activation indication of the cell discontinuous transmission or the cell discontinuous reception.

In some example embodiments, the second apparatus comprises a network device.

In some example embodiments, the second apparatus further comprises means for performing other operations in some example embodiments of the method 600 or the second device 120. In some example embodiments, the means comprises at least one processor; and at least one memory storing instructions that, when executed by the at least one processor, cause the performance of the second apparatus.

FIG. 7 is a simplified block diagram of a device 700 that is suitable for implementing example embodiments of the present disclosure. The device 700 may be provided to implement a communication device, for example, the first device 110 or the second device 120 as shown in FIG. 1. As shown, the device 700 includes one or more processors 710, one or more memories 720 coupled to the processor 710, and one or more communication modules 740 coupled to the processor 710.

The communication module 740 is for bidirectional communications. The communication module 740 has one or more communication interfaces to facilitate communication with one or more other modules or devices. The communication interfaces may represent any interface that is necessary for communication with other network elements. In some example embodiments, the communication module 740 may include at least one antenna.

The processor 710 may be of any type suitable to the local technical network and may include one or more of the following: general purpose computers, special purpose computers, microprocessors, digital signal processors (DSPs) and processors based on multicore processor architecture, as non-limiting examples. The device 700 may have multiple processors, such as an application specific integrated circuit chip that is slaved in time to a clock which synchronizes the main processor.

The memory 720 may include one or more non-volatile memories and one or more volatile memories. Examples of the non-volatile memories include, but are not limited to, a Read Only Memory (ROM) 724, an electrically programmable read only memory (EPROM), a flash memory, a hard disk, a compact disc (CD), a digital video disk (DVD), an optical disk, a laser disk, and other magnetic storage and/or optical storage. Examples of the volatile memories include, but are not limited to, a random access memory (RAM) 722 and other volatile memories that will not last in the power-down duration.

A computer program 730 includes computer executable instructions that are executed by the associated processor 710. The instructions of the program 730 may include instructions for performing operations/acts of some example embodiments of the present disclosure. The program 730 may be stored in the memory, e.g., the ROM 724. The processor 710 may perform any suitable actions and processing by loading the program 730 into the RAM 722.

The example embodiments of the present disclosure may be implemented by means of the program 730 so that the device 700 may perform any process of the disclosure as discussed with reference to FIG. 2 to FIG. 6. The example embodiments of the present disclosure may also be implemented by hardware or by a combination of software and hardware.

In some example embodiments, the program 730 may be tangibly contained in a computer readable medium which may be included in the device 700 (such as in the memory 720) or other storage devices that are accessible by the device 700. The device 700 may load the program 730 from the computer readable medium to the RAM 722 for execution. In some example embodiments, the computer readable medium may include any types of non-transitory storage medium, such as ROM, EPROM, a flash memory, a hard disk, CD, DVD, and the like. The term “non-transitory,” as used herein, is a limitation of the medium itself (i.e., tangible, not a signal) as opposed to a limitation on data storage persistency (e.g., RAM vs. ROM).

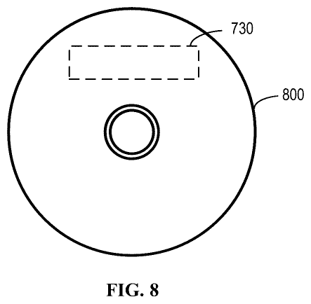

FIG. 8 shows an example of the computer readable medium 800 which may be in form of CD, DVD or other optical storage disk. The computer readable medium 800 has the program 730 stored thereon.

Generally, various embodiments of the present disclosure may be implemented in hardware or special purpose circuits, software, logic or any combination thereof. Some aspects may be implemented in hardware, and other aspects may be implemented in firmware or software which may be executed by a controller, microprocessor or other computing device. Although various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

Some example embodiments of the present disclosure also provide at least one computer program product tangibly stored on a computer readable medium, such as a non-transitory computer readable medium. The computer program product includes computer-executable instructions, such as those included in program modules, being executed in a device on a target physical or virtual processor, to carry out any of the methods as described above. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. The program code may be provided to a processor or controller of a general purpose computer, special purpose computer, or other programmable data processing apparatus, such that the program code, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program code or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, although operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, although several specific implementation details are contained in the above discussions, these should not be construed as limitations on the scope of the present disclosure, but rather as descriptions of features that may be specific to particular embodiments. Unless explicitly stated, certain features that are described in the context of separate embodiments may also be implemented in combination in a single embodiment. Conversely, unless explicitly stated, various features that are described in the context of a single embodiment may also be implemented in a plurality of embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

I/We claim:

1. An apparatus comprising:
at least one processor; and
at least one memory storing instructions that, when executed by the at least one processor, cause the apparatus to:
receive, from a network device, a configuration of a first cell, wherein the configuration comprises at least one of: a configuration of a cell discontinuous transmission for the first cell or a configuration of a cell discontinuous reception for the first cell;
receive, from the network device, an activation indication for the first cell; and
monitor a set of reference signals from the network device during an activation procedure of the first cell.

2. The apparatus of claim 1, wherein the apparatus is caused to:
determine that the cell discontinuous transmission for the first cell is deactivated based on the reception of the activation indication for the first cell.

3. The apparatus of claim 2, wherein the apparatus is caused to:
determine that the cell discontinuous transmission for the first cell is activated based on a timer after the activation procedure of the first cell.

4. The apparatus of claim 2, wherein the apparatus is caused to:
determine that the cell discontinuous transmission for the first cell is activated after the activation procedure of the first cell.

5. The apparatus of claim 1, wherein the apparatus is caused to:
in accordance with a determination that the configuration also comprises a configuration of a further cell discontinuous transmission, determine to switch from the cell discontinuous transmission to the further cell discontinuous transmission.

6. The apparatus of claim 1, wherein the set of reference signals is a set of tracking reference signals, and wherein the apparatus is caused to:
receive the set of tracking reference signals in a non-active period of the cell discontinuous transmission during the activation procedure of the first cell; and
perform the measurement on the set of tracking reference signals.

7. The apparatus of claim 1, wherein the apparatus is caused to:
determine that an active period of the cell discontinuous transmission is extended during the activation procedure of the first cell, until a valid report is transmitted by the apparatus.

8. The apparatus of claim 1, wherein the apparatus is caused to:
receive a deactivation indication of the cell discontinuous transmission from a serving cell; and
determine that the cell discontinuous transmission is deactivated before the reception of the activation indication for the first cell.

9. The apparatus of claim 1, wherein the apparatus is caused to:
determine that a cell discontinuous reception of the physical uplink control channel secondary cell is deactivated when the first cell is a secondary cell configured with physical uplink control channel, or
determine that a cell discontinuous reception of the special cell is deactivated when the first cell is a secondary cell not configured with physical uplink control channel.

10. The apparatus of claim 1, wherein the apparatus is caused to:
transmit the report regardless of a non-active period of a cell discontinuous reception of the second cell during the activation procedure of the first cell.

11. The apparatus of claim 1, wherein at least one valid report is allowed to be transmitted regardless of a non-active period of a cell discontinuous reception of the second cell during the activation procedure of the first cell.

12. An apparatus comprising:
at least one processor; and
at least one memory storing instructions that, when executed by the at least one processor, cause the apparatus to:
transmit, to a terminal device, a configuration of a first cell, wherein the configuration comprises at least one of: a configuration of a cell discontinuous transmission for the first cell or a configuration of a cell discontinuous reception for the first cell;
transmit, to the terminal device, an activation indication for the first cell; and
transmit a set of reference signals to the terminal device during an activation procedure of the first cell.

13. The apparatus of claim 12, wherein the apparatus is caused to:
deactivate the cell discontinuous transmission for the first cell based on the activation indication for the first cell.

14. The apparatus of claim 12, wherein the apparatus is caused to:
switch from the cell discontinuous transmission to a further cell discontinuous transmission.

15. The apparatus of claim 12, wherein the apparatus is caused to:
transmit, to the terminal device, the set of reference signals regardless of a non-active period of the cell discontinuous transmission during the activation procedure of the first cell.

16. The apparatus of claim 12, wherein the set of reference signals is a set of tracking reference signals, and wherein the apparatus is caused to:
transmit the set of tracking reference signals in a non-active period of the cell discontinuous transmission during the activation procedure of the first cell.

17. The apparatus of claim 12, wherein the apparatus is caused to:
extend an active period of the cell discontinuous transmission during the activation procedure of the first cell, until a valid report is received by the apparatus.

18. The apparatus of claim 12, wherein the apparatus is caused to:
transmit a deactivation indication of the cell discontinuous transmission to the terminal device; and
deactivate the cell discontinuous transmission before the activation indication for the first cell.

19. The apparatus of claim 12, wherein the apparatus is caused to:
receive, from the terminal device, a report that is based on a measurement on the set of reference signals.

20. A method comprising:
receiving, at an apparatus and from a network device, a configuration of a first cell, wherein the configuration comprises at least one of: a configuration of a cell discontinuous transmission for the first cell or a configuration of a cell discontinuous reception for the first cell;
receiving, from the network device, an activation indication for the first cell; and
monitoring a set of reference signals from the network device during an activation procedure of the first cell.
